(19) United States
(12) Patent Application Publication
(10) Pub. No.: US 2012/0099815 A1
(43) Pub. Date: Apr. 26, 2012

(54) COLLIMATING COUPLER FOR LASER TREATMENT DEVICES

(76) Inventors: Dmitri Boutoussov, Dana Point, CA (US); Michael A. Newel, Long Beach, CA (US); Boris Reichman, Stoneham, MA (US); Tamotsu Yajima, Nagahama-shi (JP)

(21) Appl. No.: 13/281,340

(22) Filed: Oct. 25, 2011

Related U.S. Application Data
(60) Provisional application No. 61/406,825, filed on Oct. 26, 2010.

(51) Int. Cl. G02B 6/26

(52) U.S. Cl. 385/27

(57) ABSTRACT

Electromagnetic energy generated by a collection of individual laser modules is coupled by corresponding individual waveguides to an input of a multi-lumen ferrule. The energy is conveyed from an output of the multi-lumen ferrule to collimating and converging assemblies before being transmitted to a trunk fiber and thence to a laser handpiece.

### CROSS-REFERENCE TO RELATED APPLICATIONS

This application claims the benefit of Prov. App. 61/406,825 (Att. Docket 1318325PR2), filed Oct. 26, 2010, and Prov. App. 61/254,845 (Att. Docket B18325PR), filed Oct. 26, 2009, the entire contents of both which are hereby incorporated by reference.

### BACKGROUND OF THE INVENTION

1. Field of the Invention

The present invention relates generally to a laser treatment (e.g., cutting) device for treating (e.g., cutting) hard and/or soft materials and, more particularly, to a laser delivery system for supplying components to the laser treatment device.

2. Description of Related Art

Typical laser treatment devices include a laser housing that contains a laser module permanently connected (e.g., pigtailed) by an optical connector to a waveguide (e.g., a fiber optic or even a trunk fiber). FIG. 1 illustrates such a conventional laser assembly with a laser housing 10 and a laser module 15 connected by an internal waveguide 20 to an optical connector 25 that couples electromagnetic energy to a trunk fiber 30, which extends up to and into an interior region of a handpiece 35. The optical connector 25 may be an SMA connector that is constructed to facilitate attachment/removal of the trunk fiber 30 to/from the waveguide 20 within the housing 10. The laser module 15 may generate, for example 1W of electromagnetic power.

If a higher-powered laser is desired, a laser treatment device such as that illustrated in FIG. 2 may be employed. This device is identical to the device of FIG. 1 except that the 1 W laser module 15 is replaced with, for example, a 7 W laser module 16.

The prior art devices of FIGS. 1 and 2 suffer from the disadvantage that neither device can has a power level that can be readily adjusted or modified once the laser module (15 or 16) is chosen. Additionally, the type of electromagnetic waveform received by the handpiece 35 is limited to that generated by the laser module.

A need thus exists in the prior art for a laser treatment device having a laser-module architecture with a readily adjustable power level. A further need exists for a laser treatment device adapted to generate a variety of electromagnetic waveforms.

### SUMMARY OF THE INVENTION

The present invention addresses these needs by providing an electromagnetic energy output apparatus that includes a plurality of electromagnetic energy modules, each module having an output coupled to a corresponding waveguide, and a multi-lumen ferrule having an input end contacting output ends of the waveguides, the multi-lumen ferrule having a proximal end, a distal end and a longitudinal axis extending therebetween. A feature of the present invention includes a collimating assembly optically aligned with the axis and disposed in a vicinity of an output end of the multi-lumen ferrule. Another feature of the present invention comprises a converging assembly optically aligned with and positioned to receive electromagnetic energy from the collimating assembly, a trunk fiber positioned to input electromagnetic energy from the converging assembly along the axis and another ferrule secured in a vicinity of the input end of the trunk fiber.

Yet another feature of the invention herein disclosed comprises an apparatus having one or more waveguides, each with an input coupled to a corresponding electromagnetic energy module, a ferrule disposed at or about an output of each of the one or more waveguides and a converging assembly positioned along a path of travel of electromagnetic energy from the one or more waveguides. The apparatus further includes a trunk fiber disposed adjacent to the converging assembly and a collimating assembly positioned between the ferrule and the converging assembly.

While the apparatus (e.g., electromagnetic energy output housing) and associated method has or will be described for the sake of grammatical fluidity with functional explanations, it is to be expressly understood that the claims, unless indicated otherwise, are not to be construed as limited in any way by the construction of “means” or “steps” limitations, but are to be accorded the full scope of the meaning and equivalents of the definition provided by the claims under the judicial doctrine of equivalents.

Any feature or combination of features described or referenced herein are included within the scope of the present invention provided that the features included in any such combination are not mutually inconsistent as will be apparent from the context, this specification, and the knowledge of one skilled in the art. In addition, any feature or combination of features described or referenced may be specifically excluded from any embodiment of the present invention. For purposes of summarizing the present invention, certain aspects, advantages and novel features of the present invention are described or referenced. Of course, it is to be understood that not necessarily all such aspects, advantages or features will be embodied in any particular implementation of the present invention. Additional advantages and aspects of the present invention are apparent in the following detailed description and claims that follow.

### BRIEF DESCRIPTION OF THE FIGURES

FIG. 1 is a sketch of a prior art laser treatment device including a single 1 W laser module;

FIG. 2 is a sketch another prior art laser treatment device having a single laser module generating 7 W of power;

FIG. 3 is a laser treatment device configured according to the present invention with multiple laser modules, a multi-lumen ferrule, and a transmission assembly;

FIG. 4 is a cross-sectional view of a multi-lumen ferrule according to the present invention;

FIG. 5A is a cross-sectional view of a multi-lumen ferrule such as that shown in FIG. 4 elucidating multiple separately identifiable lumens;

FIG. 5B is a cross-sectional view of another multi-lumen ferrule illustrating multiple overlapping lumens with shared boundaries; and

FIG. 6 is a diagram illustrating a collimating/converging transmission assembly that couples energy between a multi-lumen ferrule and a single-lumen ferrule.

### DETAILED DESCRIPTION OF THE PRESENTLY PREFERRED EMBODIMENTS

Embodiments of the invention are now described and illustrated in the accompanying drawings, instances of which are to be interpreted to be to scale in some implementations while in other implementations, for each instance, not. In certain aspects, use alike or the same reference designators in the drawings and description refers to the same, similar or analogous components and/or elements, while according to other implementations the same use should not. According to certain implementations, use of directional terms, such as, top, bottom, left, right, up, down, over, above, below, beneath, rear, and front, are to be construed literally, while in other implementations the same use should not. The present invention may be practiced in conjunction with various devices and techniques that are conventionally used in the art, and only so much of the commonly practiced process steps are included herein as are necessary to provide an understanding of the present invention.

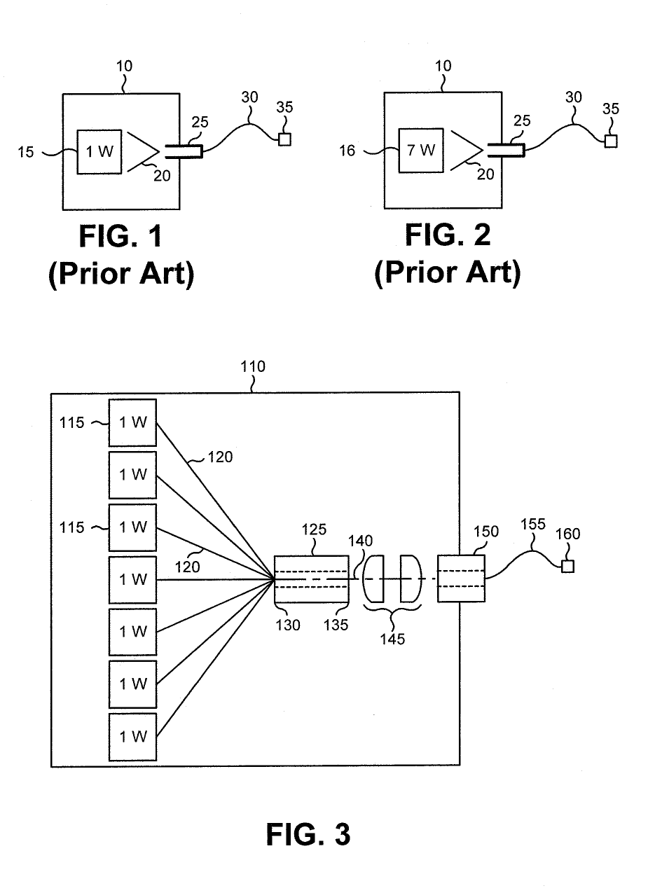

Referring with particularity to the drawings, FIG. 3 illustrates an embodiment of the present invention, the embodiment comprising a laser housing 110 having disposed therein an array (e.g., a three-or-more plurality (e.g., seven)) of preset-power (e.g. 1 W) laser modules 115, each module being coupled to an input of a waveguide 120, each waveguide 120 having an output end (e.g., output region) coupled to (e.g., disposed within or connected to) an input of a multi-lumen ferrule. According to one contemplated arrangement and not by way of limitation seven 1 W laser modules each having a construction for instance as shown in FIG. 1 are ordered from a manufacturer and then disposed within a housing with their waveguides coupled (e.g., disposed within, or connected) to a multi-lumen ferrule 125. The multi-lumen ferrule 125 can have a proximal (e.g., input) end 130, a distal (e.g., output) end 135 and a longitudinal axis 140 extending therebetween. In a typical embodiment, the proximal end 130 comprises an input end of the multi-lumen ferrule 125, and the distal end 135 comprises an output thereof. Electromagnetic energy (e.g. coherent and/or incoherent light, and/or laser energy) generated by the plurality of laser modules 115 and received by the multi-lumen ferrule 125 may be coupled by a coupling assembly 145 (e.g., an electromagnetic energy-altering transmission assembly, such as herein more particularly described), the coupling assembly 145 being optically aligned with the longitudinal axis 140, to an input of a trunk fiber 155 (e.g., a fewer-lumen waveguide, single-lumen optical trunk fiber and/or an optical fiber). The trunk fiber 155 may be disposed within a single-lumen ferrule 150 and positioned to receive electromagnetic energy from the coupling assembly 145. The single-lumen ferrule 150 may be secured in a vicinity of and/or optically aligned with an input end of the trunk fiber 155, which may terminate in a handpiece 160.

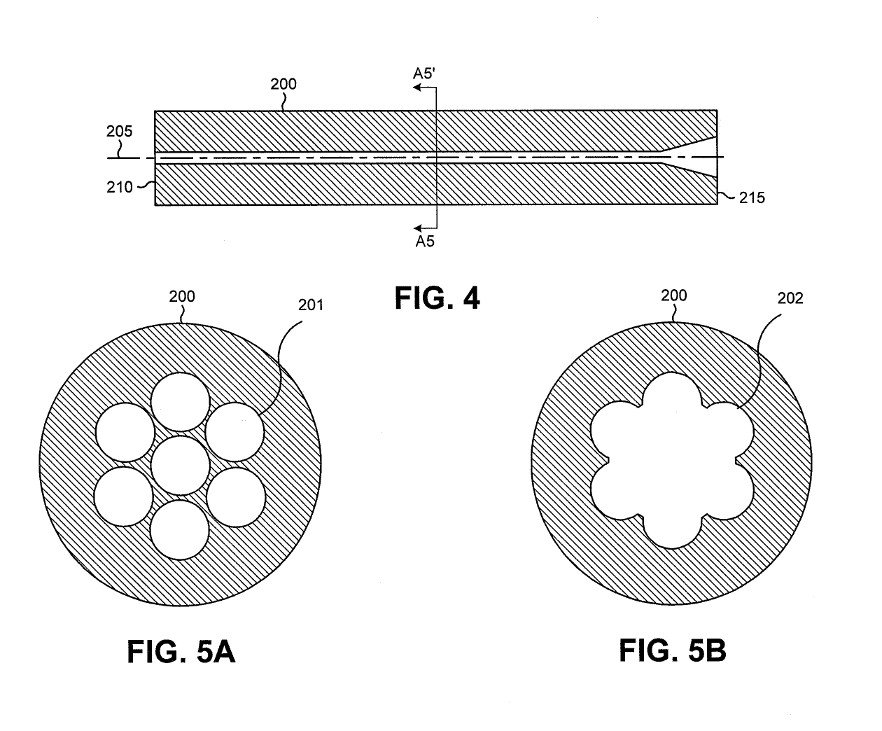

The term “multi-lumen” is intended to encompass, in different but not equivalent or interchangeable embodiments, at least either of the types of lumens depicted in FIGS. 4, 5A and 5B. FIG. 4 is a cross-sectional diagram of a multi-lumen ferrule 200 (e.g., a seven-lumen ferrule) which, according to the present invention, may be connected to receive electromagnetic energy from the plurality of waveguides 120 (cf. multi-lumen ferrule 125 of FIG. 3). The multi-lumen ferrule which may be fabricated with and/or modified to have according to the present invention a longitudinal axis 205, a proximal end 210 and a distal end 215, may comprise a plurality of lumens adapted to receive electromagnetic energy from the plurality of waveguides 120. FIG. 5A illustrates a cross-section of the multi-lumen ferrule 200 of FIG. 4 taken along a section 5-5′, the scale of FIG. 5A having been expanded for clarity. The cross-section of FIG. 5A depicts a plurality of lumens (e.g., three, four, seven as shown, or more) disposed closely together, but not sharing a boundary or overlapping, thereby rendering each of the lumens 201 separately identifiable. FIG. 5B is a cross-sectional diagram of a multi-lumen ferrule identical to the multi-lumen ferrule 200, except for having a plurality of lumens 202 that share inter-lumen volumes and/or inter-lumen boundaries. In exemplary embodiments, each of the lumens is separately identifiable and/or any overlapping, to the extent present, is about 50 percent, or about 25 percent, or not complete. While the plurality of lumens 201/202 shown in FIG. 5A/5B are depicted as being the same any one or more of the plurality of the lumens 201/202 may differ in any known characteristic or property (e.g., physical dimension and/or composition) such as, but not limited to, diameter, cross-sectional shape or area, length and/or boundary material and/or laser source active medium or structure (e.g., pump, lamp, rod, chamber, output, waveguide, etc.), relative to any one or more of the other lumens 201/202.

Although the plurality of laser modules 115 shown in FIG. 3, are depicted as being identical, any one or more of the laser modules 115 may differ in any known electromagnetic energy source property or characteristic such as, but not limited to, frequency, pulse presence or property (e.g., shape, length, on and off time), power, wavelength, laser active medium and/or structure (e.g., pump, lamp, rod, chamber, output, waveguide, etc., relative to any one or more of the other laser modules. Two or more (e.g., all) of the laser modules and/or outputs therefrom can be controlled in any way known or discernable to one skilled in the art in light of this disclosure, to achieve different forms (e.g., types and/or formats) of energy in the trunk fiber 155. For example, with reference to the particular example of FIG. 3, all of the laser modules may be combined for an output of 7 W, or, for instance, three of them may be activated and combined for a 3 W output.

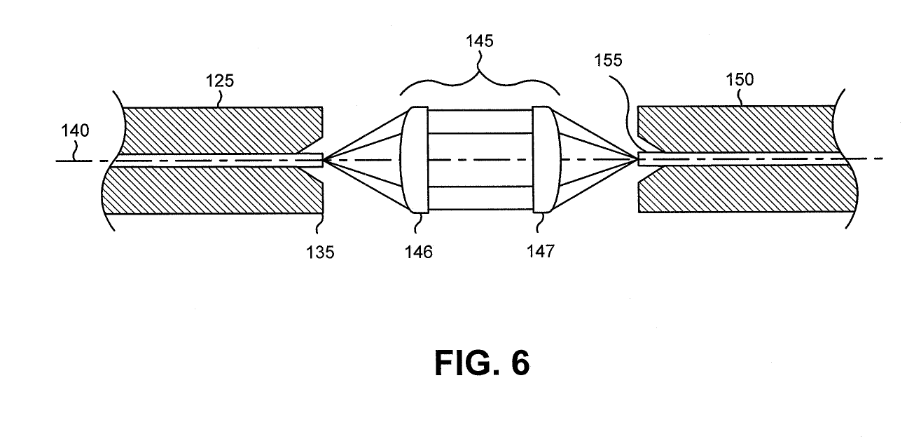

According to an aspect of the present invention, the coupling assembly 145 of FIG. 3 my comprise a transmission assembly or transmission-altering coupling assembly positioned along a path of travel of electromagnetic energy (e.g., coherent and/or incoherent light) from the laser modules, the transmission assembly being disposed in a vicinity of the output end of the multi-lumen ferrule, performing one or more of collimating and converging electromagnetic energy from the multi-lumen ferrule. According to one embodiment, the coupling assembly 145 comprises a collimating assembly 146, which is illustrated in FIG. 6. The embodiment of FIG. 6, which relates directly to the embodiment shown in FIG. 3, comprises the multi-lumen ferrule 125 having a proximal end 135, a coupling assembly 145, and a single-lumen ferrule 150 having disposed therein the trunk fiber 155. The coupling assembly 145, which is disposed in a vicinity of the output end of the multi-lumen ferrule 125 may have a longitudinal axis optically aligned with the axis 140 of the multi-lumen ferrule 125. The collimating lens assembly 146, further, may receive electromagnetic energy (e.g., coherent and/or incoherent light) from a plurality of fibers disposed within the multi-lumen ferrule 125 and may collimate (i.e., at least partially collimate, substantially collimate, form an output that is about collimated, fully collimate, or any combination or intermediary thereof) the electromagnetic energy. A further aspect of the illustrated embodiment may comprise a converging lens assembly 147, which may be optically aligned with, and positioned to receive electromagnetic energy from, the collimating assembly 146. The converging lens assembly 147 may perform converging on (e.g., at least partially converge, substantially converge, form an output that is about converged, fully converge, or any combination or intermediary thereof) the light from the collimating assembly 146 to, for example, a shape and/or diameter of a receiving waveguide (e.g., a trunk fiber 155 disposed within another ferrule such as the single-lumen ferrule 150).

In typical implementations, the multi-lumen ferrule is (but need not be limited to being) disposed in a manner so as to be attached to or within a first medium (e.g., a housing and/or optical connector), to secure, stabilize and/or protect waveguides 120 (cf. waveguides 120 in FIG. 3) within the first medium, and to comprise a ceramic or crystalline material (e.g., sapphire) formed around an output end of the waveguides 120, and the other ferrule 150 is (but need not be limited to being) disposed in a manner so as to be attached to and/or within a second medium (e.g., housing, optical connector and/or a connector (e.g., SMA connector)) for the trunk fiber 155, to secure, stabilize and/or protect the trunk fiber 155 to and/or within the second medium, and to comprise a ceramic or crystalline material (e.g., sapphire) formed around a receiving end of the trunk fiber 155. The trunk fiber 155 receiving end, which may be polished with an inputting end of the ferrule 150, can be adapted for receiving (e.g., by one or more of the converging assembly and the collimating assembly) laser radiation from the output ends of the waveguides 120, whereby, for example, the receiving end of the trunk fiber faces the output ends of the waveguides 120 (e.g., is positioned along a path of travel of light from the laser modules). in an exemplary fabrication, the multi-lumen ferrule 125 may have a diameter of about 415 microns with each lumen having a diameter of about 105 microns, and a diameter of the trunk fiber 155 may be about 200 microns.

A particular implementation of the present invention can comprise one or more of the multi-lumen ferrule 125 and another ferrule 150, the latter ferrule 150 being formed of alumina (i.e., aluminum oxide=Al₂O₃) and/or a material with, for example, good (e.g., comparable) heat conductivity. Preferred materials can be selected so as not to absorb wavelength(s) of interest (e.g., being transmitted), while such materials may be selected/modified to effectuate, or even be designed to effectuate in certain regions, scattering.

A modified, although not equivalent or interchangeable, embodiment of the invention can comprise a single-lumen ferrule instead of the multi-lumen ferrule (e.g., a single waveguide within a single-lumen ferrule or even within a multi-lumen ferrule). An alternative or additional, but not equivalent or interchangeable, feature of the invention can comprise more than one trunk fiber and/or a multi-lumen other ferrule. In another alternative or additional, but not equivalent or interchangeable, configuration an optional gas flow path can be disposed (e.g., at least partially) within the housing, as well. The gas flow path can envelop one or more parts of any of the above-mentioned elements. For example, an alternative or additional, hut not equivalent or interchangeable, implementation can comprise one or more of the multi-lumen ferrule, another ferrule, and/or any surfaces thereof, forming and/or being contacted by a fluid flow path for cooling, cleaning, etc.

According to another aspect of the present invention, a medical handpiece includes a handpiece housing and a source of electromagnetic energy disposed within the handpiece housing and adapted for emitting electromagnetic energy from a distal end of the handpiece housing. An illumination source is disposed within the handpiece housing for projecting light from the distal end of the handpiece housing onto a target surface. The illumination source may include a fiberoptic bundle. A medication line may also be disposed within the handpiece housing for outputting medication through a distal end of the handpiece housing onto a target surface.

According to certain implementations, laser energy from the trunk fiber is output from a power or treatment fiber, and is directed, for example, into fluid (e.g., an air and/or water spray or an atomized distribution of fluid particles from a water connection and/or a spray connection near an output end of a handpiece) that is emitted from a fluid output of a handpiece above a target surface (e.g., one or more of tooth, bone, cartilage and soft tissue). The fluid output may comprise a plurality of fluid outputs, concentrically arranged around a power fiber, as described in, for example, application Ser. No. 11/042,824 and Prov. App. 60/601,415. The power or treatment fiber may be coupled to an electromagnetic energy source comprising one or more of a wavelength within a range from about 2.69 to about 2.80 microns and a wavelength of about 2.94 microns. In certain implementations the power fiber may be coupled to one or more of an Er:YAG laser, an Er:YSGG laser, an Er, Cr:YSGG laser and a CTE:YAG laser, and in particular instances may be coupled to one of an Er, Cr:YSGG solid state laser having a wavelength of about 2.789 microns and an Er:YAG solid state laser having a wavelength of about 2.940 microns. An apparatus including corresponding structure for directing electromagnetic energy into an atomized. distribution of fluid particles above a target surface is disclosed, for example, in the below-referenced U.S. Pat. No. 5,574,247, which describes the impartation of laser energy into fluid particles to thereby apply disruptive forces to the target surface.

By way of the disclosure herein, a laser assembly has been described that can output electromagnetic radiation useful to diagnose, monitor and/or affect a target surface. In the case of procedures using fiber optic tip radiation, a probe can include one or more power or treatment fibers for transmitting treatment radiation to a target surface for treating (e.g., ablating) a dental structure, such as within a canal. In any of the embodiments described herein, the light for illumination and/or diagnostics may be transmitted simultaneously with, or intermittently with or separate from, transmission of treatment radiation and/or of the fluid from the fluid output or outputs.

The present invention has applicability in the field of radiation outputting systems and processes in general, such as devices (e.g., LEDs, headlamps, etc.) that emit, reflect or channel radiation. Corresponding or related structure and methods described in the following patents assigned to Biolase Technology, Inc. disclosed or referenced herein and/or in any and all co-pending, abandoned or patented application(s) naming any of the named inventor(s) or assignee(s) of this disclosure and invention, are incorporated herein by reference in their entireties, wherein such incorporation includes corresponding or related structure (and modifications thereof) in the following patents which may be, in whole or in part, (i) operable and/or constructed with, (ii) modified by one skilled in the art to be operable and/or constructed with, and/or (iii) implemented/made/used with or in combination with, any part(s) of the present invention according to this disclosure, that of the patents or below applications, application and references cited therein, and the knowledge and judgment of one skilled in the art.

Such patents include, but are not limited to U.S. Pat. No. 7,970,030 entitled Dual pulse-width medical laser with presets; U.S. Pat. No. 7,970,027 entitled Electromagnetic energy distributions for electromagnetically induced mechanical cutting; U.S. Pat. No. 7,967,017 entitled Methods for treating eye conditions: U.S. Pat. No. 7,957,440 entitled Dual pulse-width medical laser; U.S. Pat. No. 7,942,667 entitled Electromagnetic radiation emitting toothbrush and dentifrice system; U.S. Pat. No. 7,909,040 entitled Methods for treating eye conditions; U.S. Pat. No. 7,891,363 entitled Methods for treating eye conditions; U.S. Pat. No. 7,878,204 entitled Methods for treating hyperopia and presbyopia via laser tunneling; U.S. Pat. No. 7,867,223 entitled Methods for treating hyperopia and presbyopia via laser tunneling; U.S. Pat. No. 7,817,687 entitled Electromagnetic energy distributions for electromagnetically induced mechanical cutting; U.S. Pat. No. 7,815,630 entitled Target-close electromagnetic energy emitting device; U.S. Pat. No. 7,751,895 entitled Tissue treatment device and method; U.S. Pat. No. 7,702,196 entitled Modified-output fiber optic tips; U.S. Pat. No. 7,697,814 entitled Radiation emitting apparatus with spatially controllable output energy distributions; U.S. Pat. No. 7,696,466 entitled Electromagnetic energy distributions for electromagnetically induced mechanical cutting; U.S. Pat. No. 7,695,469 entitled Electromagnetic energy output system; U.S. Pat. No. 7,665,467 entitled Methods for treating eye conditions; U.S. Pat. No. 7,630,420 entitled Dual pulse-width medical laser; U.S. Pat. No. 7,620,290 entitled Modified-output fiber optic tips; U.S. Pat. No. 7,578,622 entitled Contra-angle rotating handpiece having tactile-feedback tip ferrule; U.S. Pat. No. 7,575,381 entitled Fiber tip detector apparatus and related methods; U.S. Pat. No. 7,563,226 entitled Handpieces having illumination and laser outputs; U.S. Pat. No. 7,467,946 entitled Electromagnetic radiation emitting toothbrush and dentifrice system; U.S. Pat. No. 7,461,982 entitled Contra-angle rotating handpiece having tactile-feedback tip ferrule; U.S. Pat. No. 7,461,658 entitled Methods for treating eye conditions; U.S. Pat. No. 7,458,380 entitled Methods for treating eye conditions; U.S. Pat. No. 7,424,199 entitled Fiber tip fluid output device; U.S. Pat. No. 7,421,186 entitled Modified-output fiber optic tips; U.S. Pat. No. 7,415,050 entitled Electromagnetic energy distributions for electromagnetically induced mechanical cutting; U.S. Pat. No. 7,384,419 entitled Tapered fused waveguide for delivering treatment electromagnetic radiation toward a target surface; U.S. Pat. No. 7,356,208 entitled Fiber detector apparatus and related methods; U.S. Pat. No. 7,320,594 entitled Fluid and laser system; U.S. Pat. No. 7,303,397 entitled Caries detection using timing differentials between excitation and return pulses; U.S. Pat. No. 7,292,759 entitled Contra-angle rotating handpiece having tactile-feedback tip ferrule; U.S. Pat. No. 7,290,940 entitled Fiber tip detector apparatus and related. methods; U.S. Pat. No. 7,288,086 entitled High-efficiency, side-pumped diode laser system; U.S. Pat. No. 7,270,657 entitled Radiation emitting apparatus with spatially controllable output energy distributions; U.S. Pat. No. 7,261,558 entitled Electromagnetic radiation emitting toothbrush and dentifrice system; U.S. Pat. No. 7,194,180 entitled Fiber detector apparatus and related methods; U.S. Pat. No. 7,187,822 entitled Fiber tip fluid output device; U.S. Pat. No. 7,144,249 entitled Device for dental care and whitening; U.S. Pat. No. 7,108,693 entitled Electromagnetic energy distributions for electromagnetically induced mechanical cutting; U.S. Pat. No. 7,068,912 entitled Fiber detector apparatus and related methods; U.S. Pat. No. 6,942,658 entitled Radiation emitting apparatus with spatially controllable output energy distributions; U.S. Pat. No. 6,829,427 entitled Fiber detector apparatus and related methods; U.S. Pat. No. 6,821,272 entitled Electromagnetic energy distributions for electromagnetically induced cutting; U.S. Pat. No. 6,744,790 entitled Device for reduction of thermal lensing; U.S. Pat. No. 6,669,685 entitled Tissue remover and method; U.S. Pat. No. 6,616,451 entitled Electromagnetic radiation emitting toothbrush and dentifrice system; U.S. Pat. No. 6,616,447 entitled Device for dental care and whitening; U.S. Pat. No. 6,610,053 entitled Methods of using atomized particles for electromagnetically induced cutting; U.S. Pat. No. 6,567,582 entitled Fiber tip fluid output device; U.S. Pat. No. 6,561,803 entitled Fluid conditioning system; U.S. Pat. No. 6,544,256 entitled Electromagnetically induced cutting with atomized fluid particles for dermatological applications; U.S. Pat. No. 6,533,775 entitled Light-activated hair treatment and removal device; U.S. Pat. No. 6,389,193 entitled Rotating handpiece; U.S. Pat. No. 6,350,123 entitled Fluid conditioning system; U.S. Pat. No. 6,288,499 entitled Electromagnetic energy distributions for electromagnetically induced mechanical cutting; U.S. Pat. No. 6,254,597 entitled Tissue remover and method; U.S. Pat. No. 6,231,567 entitled Material remover and method; U.S. Pat. No. 6,086,367 entitled Dental and medical procedures employing laser radiation; U.S. Pat. No. 5,968,037 entitled User programmable combination of atomized particles for electromagnetically induced cutting; U.S. Pat. No. 5,785,521 entitled Fluid conditioning system; and U.S. Pat. No. 5,741,247 entitled Atomized fluid particles for electromagnetically induced cutting.

Also, the above disclosure and referenced items, and that described on the referenced pages, are intended to be operable or modifiable to be operable, in whole or in part, with corresponding or related structure and methods, in whole or in part, described in the following published applications and items referenced therein, which applications are listed as follows: App. Pub. 20110192405 entitled Methods for treating eye conditions; App. Pub. 20110172650 entitled Methods for treating eye conditions; App. Pub. 20110165535 entitled Handpiece finger switch for actuation of handheld medical instrumentation; App. Pub. 20110151394 entitled Plaque toothtool and dentifrice system; App. Pub. 201110096802 entitled High power radiation source with active-media housing; App. Pub. 20110096549 entitled High power radiation source with active-media housing; App. Pub. 20110129789 entitled Drill and flavored fluid particles combination; App. Pub, 20110082526 entitled Target-close electromagnetic energy emitting device; App. Pub. 201110059417 entitled Fluid and pulsed energy output system; App. Pub. 20110032958 entitled Electromagnetic energy distributions for electromagnetically induced mechanical cutting; App. Pub. 20100233645 Efficient laser and fluid conditioning and cutting system; App. Pub. 20100185188 entitled Electromagnetically induced treatment devices and methods; App. Pub. 20100167228 entitled Electromagnetic radiation emitting toothbrush and dentifrice system; App. Pub. 20100151407 entitled Device having activated textured surfaces for treating oral tissue; App. Pub. 20100151406 entitled Fluid conditioning system; App. Pub, 20100145323 entitled Electromagnetic energy output system; App. Pith. 20100145323 entitled Electromagnetic energy output system; App. Pub. 20100137852 entitled Non-contact handpiece for laser tissue cutting; App. Pub. 20100100086 entitled Satellite-platformed electromagnetic energy treatment device; App. Pub. 20100125291 entitled Drill and flavored fluid particles combination; App. Pub. 20100086892 entitled Modified-output fiber optic tips; App. Pub. 20100042082 entitled Methods and devices for treating presbyopia; App. Pub. 20090298004 entitled Tunnelling probe; App. Pub. 20090281531 entitled Interventional and therapeutic electromagnetic energy systems; App. Pub, 20090225060 entitled Wrist-mounted laser with animated, page-based graphical user-interface; App. Pub. 20090143775 entitled Medical laser having controlled-temperature and sterilized fluid output; App. Pub. 20090141752 entitled Dual pulse-width medical laser with presets; App. Pub. 20090105707 entitled Drill and flavored fluid particles combination; App. Pub. 20090104580 entitled Fluid and pulsed energy output system; App. Pub, 20090076490 entitled Fiber tip fluid output device; App. Pub. 20090075229 entitled Probes and biofluids for treating and removing deposits from tissue surfaces; App. Pub. 20090067189 entitled Contra-angle rotating handpiece having tactile-feedback tip ferrule; App. Pub. 20090062779 entitled Methods for treating eye conditions with low-level light therapy; App. Pub, 20090056044 entitled Electromagnetic radiation emitting toothbrush and dentifrice system; App. Pub. 20090043364 entitled Electromagnetic energy distributions for electromagnetically induced mechanical cutting; App. Pub. 20090042171 entitled Fluid controllable laser endodontic cleaning and disinfecting system; WO 2010/051579, entitled Surface structure modification; App. Pub. 20090035717 entitled Electromagnetic radiation emitting toothbrush and transparent dentifrice system; App. Pub. 20090031515 entitled Transparent dentifrice for use with electromagnetic radiation emitting toothbrush system; App. Pub. 20090225060 entitled Wrist-mounted laser with animated, page-based graphical user-interface; App. Pub. 20090143775 entitled Medical laser having controlled-temperature and sterilized fluid output; App. Pub, 20090141752 entitled Dual pulse-width medical laser with presets; App. Pub. 20090105707 entitled Drill and flavored fluid particles combination; App. Pub. 20090104580 entitled Fluid and pulsed energy output system; App. Pub. 20090076490 entitled Fiber tip fluid output device; App. Pub. 20090075229 entitled Probes and biofluids for treating and removing deposits from tissue surfaces; App. Pith. 20090067189 entitled Contra-angle rotating handpiece having tactile-feedback tip ferrule; App. Pub, 20090062779 entitled Methods for treating eye conditions with low-level light therapy; App. Pub. 20090056044 entitled Electromagnetic radiation emitting toothbrush and dentifrice system; App. Pub. 20090043364 entitled Electromagnetic energy distributions for Electromagnetically induced mechanical cutting; App. Pub. 20090042171 entitled Fluid controllable laser endodontic cleaning and disinfecting system; App. Pub. 20090035717 entitled Electromagnetic radiation emitting toothbrush and transparent dentifrice system; App. Pub. 20090031515 entitled Transparent dentifrice for use with electromagnetic radiation emitting toothbrush system; App. Pub. 20080317429 entitled Modified-output fiber optic tips; App. Pub, 20080276192 entitled Method and apparatus for controlling an electromagnetic energy output system; App. Pub. 20080240172 entitled Radiation emitting apparatus with spatially controllable output energy distributions; App. Pub. 20080221558 entitled Multiple fiber-type tissue treatment device and related method; App. Pub, 20080219629 entitled Modified-output fiber optic tips; App. Pub. 20080212624 entitled Dual pulse-width medical laser; App. Pub. 20080203280 entitled Target-close electromagnetic energy emitting device; App. Pub. 20080181278 entitled Electromagnetic energy output system; App. Pub. 20080181261 entitled Electromagnetic energy output system; App. Pub, 20080157690 entitled Electromagnetic energy distributions for electromagnetically induced mechanical cutting; App. Pub, 20080151953 entitled Electromagnet energy distributions for electromagnetically induced mechanical cutting; App. Pub. 20080138764 entitled Fluid and laser system; App. Pub. 20080125677 entitled Methods for treating hyperopia and presbyopia via laser tunneling; App. Pub. 20080125676 entitled Methods for treating hyperopia and presbyopia via laser tunneling; App. Pub. 20080097418 entitled Methods for treating eye conditions; App. Pub, 20080097417 entitled Methods for treating eye conditions; App. Pub. 20080097416 entitled Methods for treating eye conditions; App. Pub, 20080070185 entitled Caries detection using timing differentials between excitation and return pulses; App. Pub. 20080069172 entitled Electromagnetic energy distributions for electromagnetically induced mechanical cutting; App. Pub. 20080065057 entitled High-efficiency, side-pumped diode laser system; App. Pub. 20080065055 entitled Methods for treating eye conditions; App. Pub. 20080065054 entitled Methods for treating hyperopia and presbyopia via laser tunneling; App. Pub. 20080065053 entitled Methods for treating eye conditions; App. Pub. 20080033411 entitled High efficiency electromagnetic laser energy cutting device; App. Pub. 20080033409 entitled Methods for treating eye conditions; App. Pub. 20080033407 entitled Methods for treating eye conditions; App. Pub. 20080025675 entitled Fiber tip detector apparatus and related methods; App. Pub. 20080025672 entitled Contra-angle rotating handpiece having tactile-feedback tip ferrule; App. Pub. 20080025671 entitled Contra-angle rotating handpiece having tactile-feedback tip ferrule; App. Pub. 20070298369 entitled Electromagnetic radiation emitting toothbrush and dentifrice system; App. Pub. 20070263975 entitled Modified-output fiber optic tips; App. Pub. 20070258693 entitled Fiber detector apparatus and related methods; App. Pub. 20070208404 entitled Tissue treatment device and method; App. Pub. 20070208328 entitled Contra-angle rotating handpiece having tactile-feedback tip ferrule; App. Pub, 20070190482 entitled Fluid conditioning system; App. Pub. 20070184402 entitled Caries detection using real-time imaging and multiple excitation frequencies; App. Pub, 20070128576 entitled Output attachments coded for use with electromagnetic-energy procedural device; App. Pub. 20070104419 entitled Fiber tip fluid output device; App. Pub. 20070060917 entitled High-efficiency, side-pumped diode laser system; App. Pub, 20070059660 entitled Device for dental care and whitening; App. Pub. 20070054236 entitled Device for dental care and whitening; App. Pub. 20070054235 entitled Device for dental care and whitening; App. Pub. 20070054233 entitled Device for dental care and whitening; App. Pub. 20070042315 entitled Visual feedback implements for electromagnetic energy output devices; App. Pub, 20070016176 entitled Laser handpiece architecture and methods; App. Pub. 20070014517 entitled Electromagnetic energy emitting device with increased spot size; App. Pub. 20070014322 entitled Electromagnetic energy distributions for electromagnetically induced mechanical cutting; App. Pub. 20070009856 entitled Device having activated textured surfaces for treating oral tissue; App. Pub. 20070003604 entitled Tissue coverings bearing customized tissue images; App. Pub. 20060281042 entitled Electromagnetic radiation emitting toothbrush and dentifrice system; App. Pub. 20060275016 entitled Contra-angle rotating handpiece having tactile-feedback tip ferrule; App. Pub. 20060241574 entitled Electromagnetic energy distributions for electromagnetically induced disruptive cutting; App. Pub, 20060240381 entitled Fluid conditioning system; App. Pub. 20060210228 entitled Fiber detector apparatus and related methods; App. Pub. 20060204203 entitled Radiation emitting apparatus with spatially controllable output energy distributions; App. Pub. 200601427.45 entitled Dual pulse-width medical laser with presets; App. Pub. 20060142744 entitled Identification connector for a medical laser handpiece; App. Pub. 20060142743 entitled Medical laser having controlled-temperature and sterilized fluid output; App. Pub. 20060126680 entitled Dual pulse-width medical laser; App. Pub. 20060099548 entitled Caries detection using timing differentials between excitation and return pulses; App. Pub. 20060083466 entitled Fiber tip detector apparatus and related methods; App. Pub. 20060043903 entitled Electromagnetic energy distributions for electromagnetically induced mechanical cutting; App. Pub. 200502831.43 entitled Tissue remover and method; App. Pub. 20050281887 entitled Fluid conditioning system; App. Pub. 20050281530 entitled Modified-output fiber optic tips; App. Pub. 20050256517 entitled Electromagnetically induced treatment devices and methods; App. Pub. 20050256516 entitled Illumination device and related methods; App. Pub. 20040106082 entitled Device for dental care and whitening; App. Pub. 20040092925 entitled Methods of using atomized particles for electromagnetically induced cutting; App. Pub. 20040091834 entitled Electromagnetic radiation emitting toothbrush and dentifrice system; App. Pub. 20040068256 entitled Tissue remover and method; App. Pub. 20030228094 entitled Fiber tip fluid output device; App. Pub. 20020149324 entitled Electromagnetic energy distributions for electromagnetically induced mechanical cutting; and App. Pub. 20020014855 entitled Electromagnetic energy distributions for electromagnetically induced mechanical cutting.

All of the contents of the preceding applications are incorporated herein by reference in their entireties. Although the disclosure herein refers to certain illustrated embodiments, it is to be understood that these embodiments have been presented by way of example rather than limitation. For example, any of the radiation outputs (e.g., laser outputs), any of the fluid outputs (e.g., water outputs), and any conditioning agents, particles, agents, etc., and particulars or features thereof or other features, including method steps and techniques, may be used with any other structure(s) and process described or referenced herein, in whole or in part, in any combination or permutation as a non-equivalent, separate, non-interchangeable aspect of this invention. Corresponding or related structure and methods specifically contemplated, disclosed and claimed herein as part of this invention, to the extent not mutually inconsistent as will be apparent from the context, this specification, and the knowledge of one skilled in the art, including, modifications thereto, which may be, in whole or in part, (i) operable and/or constructed with, (ii) modified by one skilled in the art to be operable and/or constructed with, and/or (iii) implemented/made/used with or in combination with, any parts of the present invention according to this disclosure; include: (I) any one or more parts of the above disclosed or referenced structure and methods and/or (II) subject matter of any one or more of the following claims and parts thereof, in any permutation and/or combination. The intent accompanying this disclosure is to have such embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention as limited only by the appended claims.

What is claimed is:

1. An electromagnetic energy (EM) output apparatus, comprising:
a plurality of EM modules, each having an output coupled to a corresponding waveguide;
a multi-lumen ferrule having an input end contacting output ends of the waveguides, the multi-lumen ferrule having a proximal end, a distal end and a longitudinal axis extending therebetween; and
a collimating assembly optically aligned with the axis and disposed in a vicinity of an output end of the multi-lumen ferrule.

2. The EM output apparatus as set forth in claim 1, further comprising:
a converging assembly optically aligned with, and positioned to receive EM from, the collimating assembly;
a trunk fiber positioned to receive EM from the converging assembly along the axis; and
another ferrule secured in a vicinity of the input end of the trunk fiber.

3. An apparatus, comprising:
one or more waveguides, each with an input coupled to a corresponding electromagnetic energy (EM) module;
a ferrule disposed about an output of each of the one or more waveguides;
a converging assembly positioned along a path of travel of EM from the one or more waveguides;
a trunk fiber disposed adjacent to the converging assembly; and
a collimating assembly positioned between the ferrule and the converging assembly.

4. The apparatus as set forth in claim 3, wherein the ferrule is a multi-lumen ferrule.

5. The apparatus as set forth in claim 3, wherein each waveguide is connected to receive EM from a corresponding one of a plurality of the EM modules and is disposed within a corresponding, separately identifiable lumen of the ferrule.

6. The apparatus as set forth in claim 3, wherein the one or more waveguides comprises seven waveguides.

7. An apparatus, comprising:
waveguides having input regions coupled to receive electromagnetic energy (EM) from EM modules;
a multi-lumen ferrule disposed about output regions of the waveguides; and
an EM-altering transmission assembly positioned along a path of travel of EM from, and to receive EM from, the EM modules, the transmission assembly being constructed and configured to perform one or more of collimating and converging of light from the EM modules.

8. The apparatus as set forth in claim 7, wherein the transmission assembly comprises a collimating assembly optically aligned with and between the multi-lumen ferrule and an EM output of the apparatus.

9. The apparatus as set forth in claim 7, wherein the transmission assembly comprises a converging assembly and a collimating assembly positioned between the multi-lumen ferrule and the converging assembly.

10. The apparatus as set forth in claim 7, further comprising a trunk fiber disposed adjacent to the transmission assembly.

11. The apparatus as set forth in claim 7, wherein the transmission assembly comprises a converging assembly.

12. The apparatus as set forth in claim 7, wherein the transmission assembly comprises a converging assembly optically aligned with and between the multi-lumen ferrule and an EM output of the apparatus.

13. The apparatus as set forth in claim 7, wherein the transmission assembly is secured in a location, and oriented in a manner, that facilitates reception of EM from the EM modules via the multi-lumen ferrule.

14. The apparatus as set forth in claim 7, comprising a converging assembly arranged and assembled to receive EM from the EM modules via a collimating assembly disposed within the transmission assembly.

15. The apparatus as set forth in claim 7, wherein the transmission assembly is functionally disposed to transmit light between the multi-lumen ferrule and an EM output of the apparatus

16. The apparatus as set forth in claim 2, wherein the converging assembly is positioned to receive EM in the form of collimated light.

17. The apparatus as set forth in claim 1, wherein one or more EM modules generates EM having a wavelength within a range from about 2.69 to about 2.80 microns or a wavelength of about 2.94 microns.

18. The apparatus as set forth in claim 1, wherein one or more EM modules is an Er:YAG, an Er:YSGG, an Er, Cr:YSGG or a CTE:YAG laser.

19. The apparatus as set forth in claim 1, wherein one or more EM modules outputs EM suitable for cutting or ablating one or more of tooth, bone, cartilage and soft tissue.

20. The apparatus as set forth in claim 1, wherein the apparatus comprises a fluid output constructed to output fluid particles, simultaneously with EM, toward a target.
